(19) United States
(12) Patent Application Publication
(10) Pub. No.: US 2014/0036162 A1
(43) Pub. Date: Feb. 6, 2014

(54) TELEVISION RECEIVER AND ELECTRONIC DEVICE

(71) Applicant: KABUSHIKI KAISHA TOSHIBA, Tokyo (JP)

(72) Inventors: Yuki SATO, Ome-shi (JP); Yuji NAKAJIMA, Nishitama-gun (JP)

(73) Assignee: KABUSHIKI KAISHA TOSHIBA, Tokyo (JP)

(21) Appl. No.: 13/962,797

(22) Filed: Aug. 8, 2013

Related U.S. Application Data
(63) Continuation of application No. PCT/JP2013/057944, filed on Mar. 13, 2013.

(30) Foreign Application Priority Data
Jul. 31, 2012 (JP) 2012-170318

(51) Int. Cl. G06F 1/16

(52) U.S. Cl. CPC G06F 1/1652
USPC 348/836

(57) ABSTRACT

According to one embodiment, a television receiver includes a bendable display, a housing, and a puller. The bendable display includes a front surface at which an image can be viewed and a rear surface opposite the front surface. The housing is configured to support the display. The housing includes a wall covering the rear surface. The puller is between the housing and the display, and configured to impart tensional force to the display by pulling the display in a plurality of directions along the front surface.

### CROSS-REFERENCE TO RELATED APPLICATIONS

This application is a continuation of PCT international application Ser. No. PCT/JP2013/057944, filed on Mar. 13, 2013, which designates the United States, incorporated herein by reference, and which is based upon and claims the benefit of priority from Japanese Patent Application No. 2012-170318, filed on Jul. 31, 2012, the entire contents of which are incorporated herein by reference.

### FIELD

Embodiments described herein relate generally to a television receiver and an electronic device.

### BACKGROUND

There has been known an electronic device having a flexible display.

For such electronic device, it is preferred to prevent the flexible display from being loosened or obtaining wrinkles thereon.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary front view of a television receiver according to a first embodiment;

FIG. 2 is an exemplary side view of the television receiver in the first embodiment;

FIG. 3 is an exemplary schematic diagram of an internal structure of a housing of the television receiver in the first embodiment in rear view;

FIG. 4 is an exemplary perspective view of an electronic device according to a second embodiment;

FIG. 5 is an exemplary schematic diagram of an internal structure of a second housing of the electronic device in the second embodiment in front view;

FIG. 6 is an exemplary schematic diagram of an internal structure of a second housing of an electronic device as viewed from front thereof, according to a third embodiment;

FIG. 7 is an exemplary schematic diagram of an internal structure of a second housing of an electronic device as viewed from front thereof, according to a fourth embodiment;

FIG. 8 is an exemplary plan view of a portion of a puller of the electronic device in the fourth embodiment;

FIG. 9 is an exemplary sectional view of the portion of the puller, taken along line IX-IX of FIG. 8, in the fourth embodiment;

FIG. 10 is an exemplary schematic diagram of a portion of the internal structure of the second housing of the electronic device as viewed from front thereof, according to a first modification of the embodiment;

FIG. 11 is an exemplary schematic diagram of a portion of the internal structure of the second housing of the electronic device as viewed from front thereof, according to a second modification of the embodiment;

FIG. 12 is an exemplary side view of a spring member of the electronic device in the second modification;

FIG. 13 is an exemplary schematic diagram of a portion of the internal structure of the second housing of the electronic device as viewed from front thereof, according to a third modification;

FIG. 14 is an exemplary side view of a spring member of the electronic device in the third modification;

FIG. 15 is an exemplary plan view of the spring member of the electronic device in the third modification;

FIG. 16 is an exemplary schematic diagram of a portion of the internal structure of the second housing of the electronic device as viewed from front thereof, according to a fourth modification;

FIG. 17 is an exemplary explanatory view of an assembly of a puller and the second housing of the electronic device in the fourth modification;

FIG. 18 is an exemplary perspective view of the puller of the electronic device in the fourth modification;

FIG. 19 is an exemplary perspective view of a puller of the electronic device according to a fifth modification;

FIG. 20 is an exemplary cross sectional view of the puller and the second housing of the electronic device in the fifth modification;

FIG. 21 is an exemplary perspective view of a puller of the electronic device according to a sixth modification;

FIG. 22 is an exemplary schematic diagram of a portion of the internal structure of the second housing of the electronic device as viewed from front, according to a seventh modification;

FIG. 23 is an exemplary schematic diagram of a section taken along a line XXIII-XXIII of FIG. 22, in the seventh modification;

FIG. 24 is an exemplary plan view of an elastic body of the electronic device in the seventh modification;

FIG. 25 is an exemplary perspective view of a portion of the internal structure of the second housing of the electronic device according to an eighth modification;

FIG. 26 is an exemplary schematic view of a portion of the internal structure of the second housing of the electronic device as viewed from rear thereof, according to a ninth modification; and

FIG. 27 is an exemplary schematic diagram of a section taken along a line XXVII-XXVII of FIG. 26, in the ninth modification.

### DETAILED DESCRIPTION

In general, according to one embodiment, a television receiver comprises a bendable display, a housing, and a puller. The bendable display comprises a front surface at which an image can be viewed and a rear surface opposite the front surface. The housing is configured to support the display. The housing comprises a wall covering the rear surface. The puller is between the housing and the display, and configured to impart tensional force to the display by pulling the display in a plurality of directions along the front surface.

The following exemplary embodiments and modifications include the same elements. The same elements are labeled with the same reference numerals and the duplicated descriptions are omitted.

In the following embodiments and modifications, a television receiver and a personal computer are described as examples of an electronic device. The electronic devices according to the embodiments, however, are not limited to the television receiver and the personal computer. Examples of the electronic devices according to the embodiments include cellular phones, smartphones, personal digital assistants (PDAs), office equipment, electronic dictionaries, game machines, image display devices, and image reproducers.

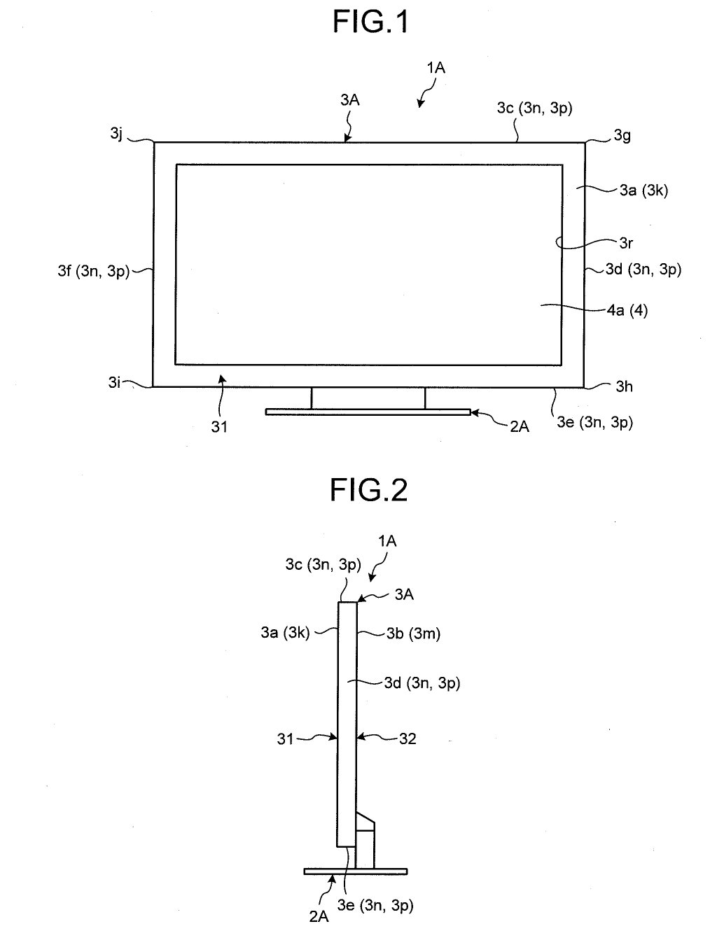

In a first embodiment, as exemplarily illustrated in FIGS. 1 and 2, a television receiver 1A, which is an example of the electronic device, comprises a supporter 2A (a support, a table, or a stand) and a housing 3A. Specifically, the supporter 2A is placed on a placement portion (a placement surface, which is not illustrated) of a desk, a rack, or a table, for example, and supports the housing 3A in a standing state. The supporter 2A may support the housing 3A in a fixed state or in a movable state (a rotatable or slidable state). Examples of a moving manner (rotation manner) of the housing 3A with respect to the supporter 2A include tilting, swiveling, and pivoting.

In the first embodiment, as exemplarily illustrated in FIG. 1, the housing 3A has a quadrangular shape (in the embodiment, e.g., a rectangular shape) when viewed in a thickness direction thereof (in front view and in rear view). As illustrated in FIG. 2, the housing 3A is configured in a flat rectangular parallelepiped shape having a small thickness in the thickness direction (front-back direction). The housing 3A has a surface 3a (a front, a front surface, or a face portion) and a surface 3b (a rear, a rear surface, or a face portion) opposite the surface 3a. The surfaces 3a and 3b extend (are widen) along a direction intersecting the thickness direction (in the embodiment, e.g., a direction orthogonal to the thickness direction). The surfaces 3a and 3b are approximately in parallel with each other. As illustrated in FIG. 1, the housing 3A has four edges 3c to 3f (sides or frames) and four corners 3g to 3j (sharp edges, bent portions, or edges) in front view (or in rear view). The edges 3c and 3e are examples of a long side. The edges 3d and 3f are examples of a short side. The housing 3A can function as a container portion housing components (not illustrated) and also as a supporter supporting heavy weight components (such as circuit boards and parts), for example.

The housing 3A has a wall 3k (a portion, a plate, a frame, a front wall, a frontward wall, or a ceiling wall) including the surface 3a and a wall 3m (a portion, a plate, a back wall, a backward wall, or a bottom wall) including the surface 3b. The walls 3k and 3m have a quadrangular shape (in the embodiment, e.g., a rectangular shape) when viewed in the thickness direction (in plan view). The wall 3k has a frame shape while the wall 3m has a platy shape. The housing 3A has four walls 3n (portions, plates, side walls, edge walls, upright walls, or extending portions) including a surface 3p (a side surface or a surrounding surface) that extends between the walls 3k and 3m. The wall 3k is provided with an opening 3r having a quadrangular shape.

A space (not illustrated) is provided in the housing 3A. The space is enclosed by the walls 3k, 3m, and 3n. That is, the space is present between the walls 3k and 3m, and extends between the edges 3c and 3e, and between the edges 3d and 3f. The space allows various components such as a battery, boards (such as a circuit board, a control board, and a sub board), various modules, an optical disk drive (ODD), a hard disk drive (HDD), a solid state drive (SSD), an antenna, a camera module, a speaker unit, a connector unit, an operation unit (switch), and a sensor unit to be housed therein.

On the boards provided in the space, a plurality of components (not illustrated) can be mounted, such as a central processing unit (CPU), a graphic controller, a power source circuit component, a platform controller hub (PCH), a memory slot connector, a liquid crystal display (LCD) connector, an input/output (I/O) connector, a power source coil, an element, and a connector. The control circuit can comprise a video signal processing circuit, a tuner, a high-definition multimedia interface (HMDI) signal processor, an audio video (AV) input terminal, a remote controller signal receiver, a controller, a selector, an on-screen display interface, a storage such as a read only memory (ROM), a random access memory (RAM), a hard disk drive (HDD), or a solid state drive (SSD), and a voice signal processing circuit. The control circuit controls output of images (moving images and still images) on a display screen (a surface 4a) of a display 4, output of voices from speakers (not illustrated), and light emission of light emitting diodes (LEDs) (not illustrated). The display 4, the speakers, and the LEDs are examples of an output module.

The housing 3A can be configured by combining a plurality of components (divided bodies or members). For example, the housing 3A comprises a member 31 (a front side member, a mask, a mask portion, a cover, a front cover, a cover portion, a bezel, a frame, a portion, or a region) including at least the wall 3k, and a member 32 (a back side member, a base, a base portion, a bottom, a bottom portion, a cover, a rear cover, a cover portion, a portion, or a region) including at least the wall 3m. In the embodiment, the walls 3n are configured as a portion of the member 32, for example. The housing 3A can comprise another member (an intermediate member, a separating member, a barrier member, a wall member, an intercalated member, a cover member, an inner plate, a middle plate, a middle frame, a shield, a portion or a region), which is other than the members 31 and 32, and is not illustrated. A portion of the other member can include a portion of the walls 3k, 3m, and 3n. The members 31 and 32, and the other member can be made of a metal material or a synthetic resin material, for example. The members 31 and 32 can be made of the same material or can be made of materials partially different from each other. A wall (a protrusion or a protruding wall, which is not illustrated) such as a rib can be provided to the members 31 and 32 at an inside of the housing 3A. The walls readily enhance the stiffness of the housing 3A.

In the embodiment, the display 4 (a display unit, a display device, or a component) is flexible, floppy, and bendable, and has a sheet (film) shape having a small thickness, for example. Examples of the display 4 include a liquid crystal display (LCD) and an organic electroluminescent display (GELD). The display 4 has a quadrangular shape (in the embodiment, e.g., a rectangular shape) when viewed in the thickness direction (in plan view), for example. The display 4 has the surface 4a (a front surface, a front, an upper surface, a surface, a display surface, or a display screen) from which images can be seen, and a surface 4b (a back surface, a rear, a lower surface, or a rear surface) opposite the surface 4a. The display 4 has four edges 4c to 4f (sides or frames) and four corners 4g to 4j (sharp edges, bent portions, or edges) in plan view. The edges 4c and 4e are examples of the long side. The edges 4d and 4f are examples of the short side. A non-display area 4p is provided on the rim (edges 4c to 4f) of the display 4 in a belt-like shape.

In the embodiment, the display 4 is provided with a touch sensor (not illustrated), for example. The touch sensor, which is transparent, can be positioned in a layer comprised in the display 4 or a layer covering the surface 4a of the display 4.

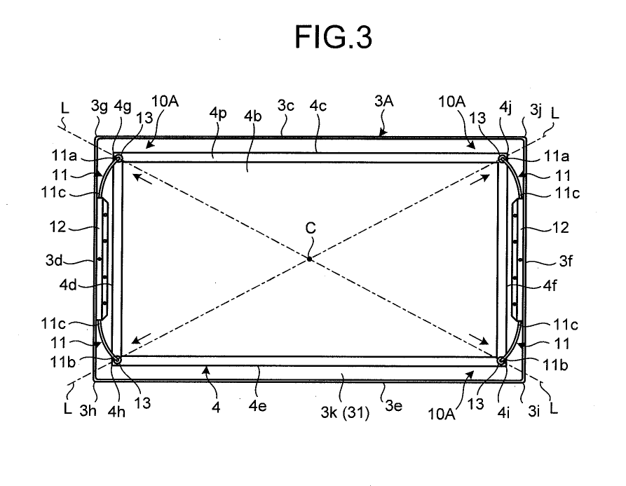

The display 4 is readily loosened or readily obtains wrinkles thereon due to its flexibility. To address such a situation, in the embodiment, the display 4 is pulled by pullers 10A in a direction along the surface 4a (or the surface 4b) relative to the housing 3A. In the embodiment, as exemplarily illustrated in FIG. 3, the pullers 10A are fixed to the member 31 (e.g., the wall 3k or the wall 3n). The puller 10A has a spring member 11 (pulling member) and connection portions 12 and 13. In the example of FIG. 3, the spring member 11 is an elastically deformable member having a rod or wire shape, for example. The spring member 11 is made of a stainless steel wire or a piano wire, for example. Edges 11a at one side in the longitudinal direction of the respective spring members 11 are fixed to (supported by) the respective corners 4g and 4j of the display 4 with the connection portions 13 interposed therebetween while edges 11b at the other side in the longitudinal direction of the respective spring members 11 are connected (bonded or fixed) to the respective corners 4h and 4i of the display 4 with the connection portions 13 interposed therebetween. In each spring member 11, intermediate portions 11c in the longitudinal direction of the spring member 11 are connected (bonded or fixed) to the member 31 (the housing 3A) with the connection portion 12 interposed therebetween. The spring members 11 extend in a straight line manner along the respective edges 3d and 3f of the housing 3A when they are in a free state while no external force is applied thereto. The edges 11a and 11b of the spring members 11 are connected to the respective connection portions 13 while they are elastically bent toward the center C (a central area) of the display 4 along the wall 3k (i.e., along the surfaces 4a and 4b). As a result, elastic force (restoring force) acts on the corners 4g to 4j of the display 4 toward the positions of the edges 11a and 11b in the original extending state (free state) (positions near the edges 3d and 3f). In addition, when the edges 11a and 11b are connected to the respective connection portions 13 as exemplarily illustrated in FIG. 3 in the embodiment, the extending directions of the spring members 11 at the respective edges 11a and 11b (tangential directions) are approximately orthogonal to the respective extending directions of the lines connecting the center C and the respective connection portions 13. Consequently, a force acts on the four corners 4g to 4j of the display 4 in a radial fashion along four lines L extending from the center C toward the respective corners 4g to 4j. The force having approximately the same magnitude acts on each of the corners 4g to 4j. Accordingly, tensional force corresponding to the external force by the pullers 10A is imparted to the surfaces 4a and 4b of the display 4, for example, in the embodiment. As a result, it becomes difficult for the display 4 to be loosened and to obtain wrinkles thereon, for example.

As described above, in the embodiment, the television receiver 1A comprises the pullers 10A that are provided between the housing 3A and the display 4, and impart tensional force to the display 4 by pulling the display 4 in a plurality of directions along the surface 4a (or the surface 4b), for example. As a result, according to the embodiment, it becomes difficult for the display 4 to be loosened and to obtain wrinkles on the surfaces 4a and 4b, for example. The display 4 may be loosened or obtain wrinkles thereon when a temperature difference occurs in the environment or when components in the housing 3A generate heat, and the display 4 and the housing 3A have different rates of thermal expansion (linear expansion coefficient or volume expansion coefficient), for example. Even in such a case, the television receiver 1A according to the embodiment readily suppresses the occurrence of loosening and wrinkles of the display 4 because the television receiver 1A comprises the pullers 10A. The term “pull” does not mean the way of imparting force to the display 4 by the pullers 10A but means that tensional force is imparted to the display 4. That is, contracting or compressing may be the motions of the pullers 10A. The pullers 10A can be provided to another member (the member 32, or another member provided between the members 31 and 32 (not illustrated)) other than the member 31.

In the embodiment, the pullers 10A pull the display 4 toward both sides from the center C (central area) of the display 4, for example. The pullers 10A pull the display 4 in a plurality of directions extending from the center C in a radial fashion. As a result, according to the embodiment, it further becomes difficult for the display 4 to be loosened as well as to obtain wrinkles thereon in comparison to the case when the display 4 is not pulled toward both sides from the center C or in a plurality of directions extending from the center C in a radial fashion, for example. In the embodiment, the pullers 10A pull the display 4 in opposing directions from the center C on straight lines. The pulling directions, however, are not always necessarily on straight lines.

In the television receiver 1A according to embodiment, the puller 10A provided on the left side in FIG. 3 is commonly used for a plurality of corners (in the embodiment, e.g., two corners 4g and 4h (edges or points of application of force)) and applies force to the respective corners 4g and 4h, while the puller 10A provided on the right side in FIG. 3 is commonly used for a plurality of corners (in the embodiment, e.g., two corners 4i and 4j) and applies force to the respective corners 4i and 4j, for example. According to the embodiment, the number of components is more readily reduced than a case when the puller 10A is provided for each of the corners 4g to 4j, for example. As a result, manufacturing time and costs of the television receiver 1A are readily reduced, for example.

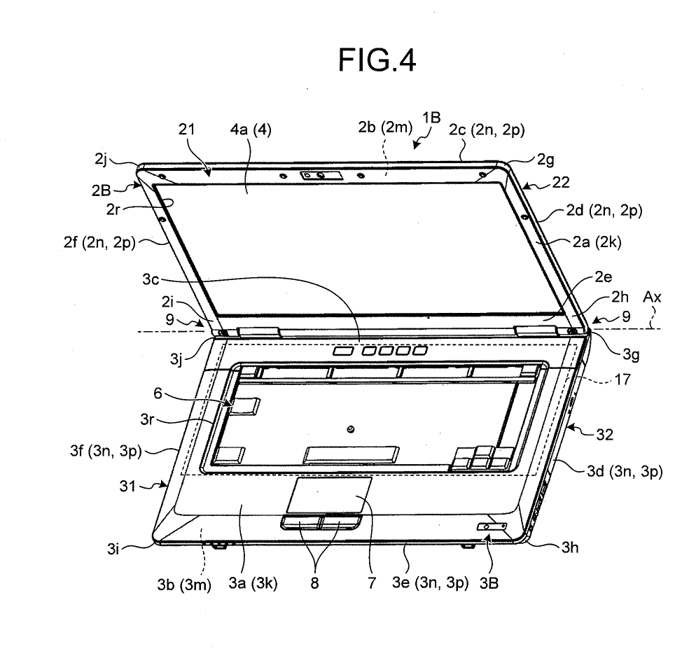

In a second embodiment, as exemplarily illustrated in FIG. 4, an electronic device 1B is a so-called notebook (clamshell) personal computer, for example. The electronic device 1B comprises a housing 2B (a second housing or a second portion) and a housing 3B (a first housing or a first portion). The housing 3B houses a board 17. The housing 2B houses at least a portion of the display 4 having flexibility. The housing 3B is provided with a keyboard 6 (an input operation module, an input reception module, or an input module), a touch pad 7 (an input operation module, an input reception module, or an input module), and click buttons 8 (input operation modules, input reception modules, or input modules), for example.

The housings 2B and 3B are rotatably connected by hinges 9 (connectors, joints, rotation supports, hinge mechanisms, connection mechanisms, joint mechanisms, or rotation support mechanisms). The housings 2B and 3B are rotatably connected by the hinges 9 between at least an open state illustrated in FIG. 4 and a fold state, which is not illustrated. In the second embodiment, the hinges 9 connect the housings 2B and 3B rotatably about a rotation axis Ax, for example. The surface 4a of the display 4 is exposed from an opening 2r provided on a surface 2a (a front, a front surface, or a surface portion) of the housing 2B. The keyboard 6, the touch pad 7, and the click buttons 8 are exposed on a surface 3a (a front, an upper surface, or a surface portion) of the housing 3B. In the fold state, the surface 2a of the housing 2B and the surface 3a of the housing 3B overlap with each other, so that the surface 4a, the keyboard 6, the touch pad 7, and the click buttons 8 are hidden by the housings 2B and 3B. In the open state, the surface 2a of the housing 2B and the surface 3a of the housing 3B are exposed, so that the surface 4a, the keyboard 6, the touch pad 7, and the click buttons 8 are usable (can be viewed or operated). In FIG. 4, only some of the keys of the keyboard 6 are illustrated.

In the embodiment, as exemplarily illustrated in FIG. 4, the housing 2B has a quadrangular shape (in the embodiment, e.g., a rectangular shape) when viewed in the thickness direction (in front view and in rear view). In the embodiment, the housing 2B is formed in a flat rectangular parallelepiped shape having a small thickness in the front-back direction (the thickness direction of the housing 2B), for example. The housing 2B has the surface 2a and a surface 2b (a rear surface, a rear, or a surface portion) opposite the surface 2a. The surfaces 2a and 2b extend (widen) in a direction intersecting the thickness direction (in the embodiment, e.g., in a direction orthogonal to the thickness direction). The housing 2B has four edges 2c to 2f (sides or frames) and four corners 2g to 2j (sharp edges, bent portions, or edges) in front view. The edges 2c and 2e are examples of the long side. The edges 2d and 2f are examples of the short side.

The housing 2B has a wall 2k (a portion, a plate, a frame, a front wall, a frontward wall, or a ceiling wall) including the surface 2a and a wall 2m (a portion, a plate, a back wall, a backward wall, or a bottom wall) including the surface 2b. The walls 2k and 2m have a quadrangular shape (in the embodiment, e.g., a rectangular shape) when viewed in the thickness direction (in plan view and in rear view). The wall 2k has a frame shape while the wall 2m has a platy shape. The housing 2B has four walls 2n (portions, plates, side walls, edge walls, upright walls, or extending portions) including a surface 2p (a side surface or a surrounding surface) that extends between the walls 2k and 2m. The wall 2k is provided with the opening 2r having a quadrangular shape.

The housing 2B can be configured by combining a plurality of components (divided bodies or members). For example, the housing 2B comprises a member 21 (a front side member, a mask, a mask portion, a cover, a front cover, a cover portion, a bezel, a frame, a portion, or a region) including at least the wall 2k and a member 22 (a back side member, a base, a base portion, a bottom, a bottom portion, a cover, a rear cover, a cover portion, a portion, or a region) including at least the wall 2m. In the embodiment, the walls 2n are configured as a portion of the member 22, for example. The members 21 and 22 can be made of a metal material or a synthetic resin material, for example. The members 21 and 22 can be made of the same material or can be made of materials partially different from each other. A wall (a protrusion or a protruding wall, which is not illustrated) such as a rib can be provided to the members 21 and 22 at an inside of the housing 2B. The walls readily enhance the stiffness of the housing 2B.

On the other hand, in the embodiment, as exemplarily illustrated in FIG. 4, the housing 3B has a quadrangular shape (in the embodiment, e.g., a rectangular shape) when viewed in the thickness direction (in front view and in rear view). In the embodiment, the housing 3B is formed in a flat rectangular parallelepiped shape having a small thickness in the upper-lower direction (the thickness direction of the housing 3B or a Z direction), for example. The housing 3B has a surface 3a (an upper surface, a front surface, or a face portion) and a surface 3b (a lower surface, a rear surface, or a face portion) opposite the surface 3a. The surfaces 3a and 3b extend (widen) in a direction intersecting the thickness direction (in the embodiment, e.g., in a direction orthogonal to the thickness direction). The housing 3B has four edges 3c to 3f (sides or frames) and four corners 3g to 3j (sharp edges, bent portions, or edges) in plan view. The edges 3c and 3e are examples of the long side. The edges 3d and 3f are examples of the short side. The housing 3B can function as a container housing components such as the board 17 and also can function as a supporter supporting heavy weight components (components, etc.), for example.

The housing 3B has a wall 3k (a portion, a plate, a frame, an upper wall, a frontward wall, or a ceiling wall) including the surface 3a and a wall 3m (a portion, a plate, a lower wall, a backward wall, or a bottom wall) including the surface 3b. The walls 3k and 3m have a quadrangular shape (in the embodiment, e.g., a rectangular shape) when viewed in the thickness direction (in front view and in rear view). The wall 3k has a frame shape while the wall 3m has a platy shape. The housing 3B has four walls 3n (portions, plates, side walls, edge walls, upright walls, or extending portions) including a surface 3p (a side surface or a surrounding surface) that extends between the walls 3k and 3m. The wall 3k is provided with an opening 3r having a quadrangular shape.

The housing 3B can be configured by combining a plurality of components (divided bodies or members). For example, the housing 3B comprises a member 31 (an upper side member, a mask, a mask portion, a cover, an upper cover, a cover portion, a bezel, a frame, a portion, or a region) including at least the wall 3k and a member 32 (a lower side member, a base, a base portion, a bottom, a bottom portion, a cover, a lower cover, a cover portion, a portion, or a region) including at least the wall 3m. In the embodiment, the walls 3n are configured as a portion of the member 32, for example. The housing 3B can comprise another member (an intermediate member, a separating member, a barrier member, a wall member, an intercalated member, a cover member, an inner plate, a middle plate, a middle frame, a shield, a portion or a region), which is other than the members 31 and 32 and is not illustrated. A portion of the other member can include a portion of the walls 3k, 3m, and 3n. The members 31 and 32, and the other member can be made of a metal material or a synthetic resin material, for example. The members 31 and 32 can be made of the same material or can be made of materials partially different from each other. A wall (a protrusion or a protruding wall, which is not illustrated) such as a rib can be provided to the members 31 and 32 at an inside of the housing 3B. The walls readily enhance the stiffness of the housing 3B.

In the embodiment, on the board 17 in the housing 3B, a plurality of components (not illustrated) can be mounted. Examples of the components include a CPU, a graphic controller, a power source circuit part, a PCH, a memory slot connector, an LCD connector, an I/O connector, a power source coil, an element, and a connector. The control circuit can comprise a video signal processing circuit, a tuner, an HMDI signal processor, an AV input terminal, a remote controller signal receiver, a controller, a selector, an on-screen display interface, a storage such as a ROM, a RAM, an HDD, or an SSD, and a voice signal processing circuit. The control circuit controls output of images (moving images and still images) on the surface 4a of the display 4, output of voices from speakers (not illustrated), and LEDs (not illustrated). The display 4, the speakers, and the LEDs are examples of the output module.

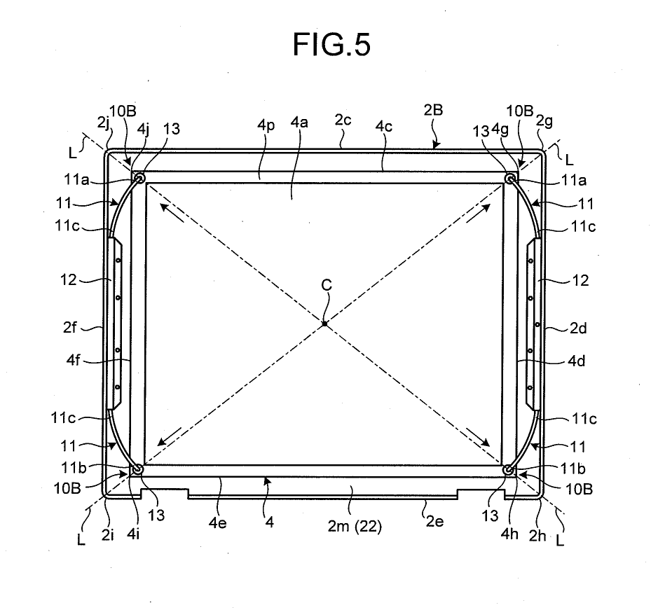

In the embodiment, as exemplarily illustrated in FIG. 5, the housing 2B houses the display 4 in the same manner as the first embodiment. That is, pullers 10B are provided in the housing 2B in the same manner as the first embodiment and pull the four corners 4g to 4j of the display 4 in a radial fashion. As a result, the electronic device 1B according to the second embodiment can obtain the same results as the television receiver 1A according to the first embodiment on the basis of the same configuration as the television receiver 1A.

As for the configuration of the second embodiment, the pullers 10B are provided on the wall 2m of the housing 2B, i.e., on the wall 2m opposite the surface 4a of the display 4, for example. When the width of the peripheral area of the opening 2r is narrow, it is sometimes difficult to provide the pullers 10B on the wall 2k. However, the configuration of the second embodiment causes less inconvenience than such case because the pullers 10B are provided on the wall 2m, which is positioned opposite the surface 4a and covers the surface 4b, for example.

An electronic device 1C according to a third embodiment comprises a similar configuration as that of the television receiver 1A of the first embodiment or the electronic device 1B according to the second embodiment. As a result, the electronic device 1C according to the third embodiment can obtain a similar result to that of the television receiver 1A or the electronic device 1B on the basis of the similar configuration to that of the television receiver 1A or the electronic device 1B.

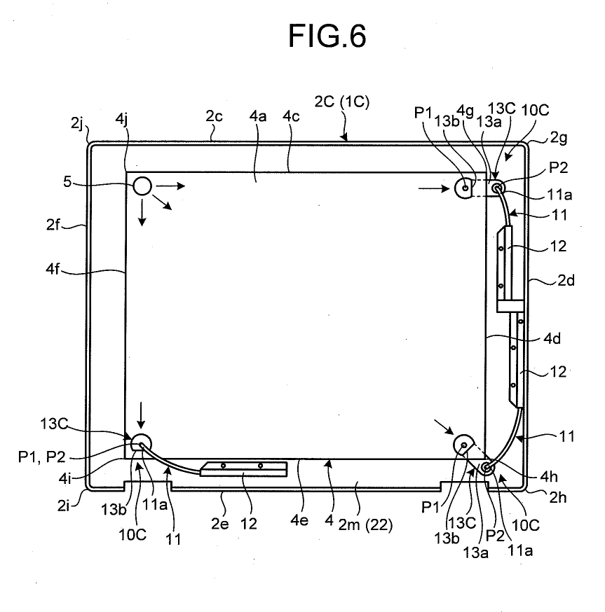

In the third embodiment, the positions supporting the display 4 by a housing 2C, the number of points of force applied to the display 4 by pullers 10C, and directions of force applied to the display 4 by the pullers 10C differ from those in the first and the second embodiments, for example. That is to say, in the third embodiment, as exemplarily illustrated in FIG. 6, one of the four corners 4g to 4j of the display 4 (in the embodiment, e.g., the corner 4j (a first corner or an edge)) is supported by the housing 2C (a supporting portion 5), and the pullers 10C pull the three corners 4g to 4i (second corners or edges) toward a side opposite the edge 4j (in directions away from the corner 4j). With such configuration, it becomes difficult for the display 4 to be loosened and to obtain wrinkles thereon. According to the embodiment, the numbers of connection portions 13C and pullers 10C are more readily reduced than the first and the second embodiments. As a result, manufacturing time and costs of the electronic device 1C can readily be reduced, for example. In the embodiment, the corner 4j is supported by the housing 2C and the other corners 4g to 4i are pulled by the pullers 10C as an example. Here, the configuration for pulling is not limited to this example. A portion other than the corners 4g to 4j of the edges 4c to 4f may be supported by the housing 2C and portions of the edges 4c to 4f other than the portion may be pulled by the pullers 10C. A plurality of positions of the display 4 may be supported by (connected to) the housing 2C and the pullers 10C may pull the display 4 at positions facing the respective corresponding supporting positions in directions away from the respective supporting positions, for example.

In the embodiment, the configuration of the connection portion 13C differs from those in the first and the second embodiments. That is, in the third embodiment, as exemplarily illustrated on the upper right side and the lower right side in FIG. 6, the connection portion 13C (the connection member, the exerting member, the member, or the component) is connected to the display 4 at a connection position P1 and is connected to the spring member 11 at a connection position P2 that is apart from the connection position P1. This configuration allows the magnitude and applying direction, for example, of tensional force to be more readily adjusted by the setting of conditions such as the arrangement of the connection positions P1 and P2, and the length and direction of an extending portion 13a (an extension portion or an arm) that extends between the connection positions P1 and P2.

In the embodiment, the connection portion 13C has a surface 13b (a line or a flat) intersecting a direction along which the puller 10C imparts force (in the embodiment, e.g., the surface 13b is orthogonal to the direction), for example. According to the embodiment, a surface pressure acting on the display 4 or the connection portion 13C caused by force imparted by the puller 10C is readily reduced, for example. As a result, durability of the display 4 and the connection portions 13C is readily increased, for example, or the tensional force is ready increased, for example. In the embodiment, the pullers 10C are provided to the respective corners 4g to 4i (the edges or the points of application of force) as an example. The arrangement of the pullers, however, is not limited to this example. The pullers 10C may be used in common with the corners 4g to 4j in the same manner as the first and the second embodiments.

In the embodiment, as exemplarily illustrated in FIG. 6, the corner 4j (the edge) at which the display 4 is supported by the housing 2C is positioned at the upper side of the display 4 during usage of the display 4 (in the standing state). In the standing state, the gravity force acts on the display 4. Accordingly, the weight of the display 4 acts as a tensional force in the configuration in which the housing 2C supports the upper side of the display 4, for example. As a result, tensional force by the pullers 10C is readily suppressed from being reduced by the gravity force, thereby more readily increasing the tensional force applied to the display 4, for example.

An electronic device 1D according to a fourth embodiment comprises a similar configuration as that of the television receiver 1A according to the first embodiment or those of the electronic devices 1B and 1C according to the second and the third embodiment. As a result, the electronic device 1D according to the fourth embodiment can obtain a similar result as that of the television receiver 1A, the electronic devices 1B, or the electronic device 1C on the basis of the similar configuration as that of the television receiver 1A, the electronic device 1B, or 1C.

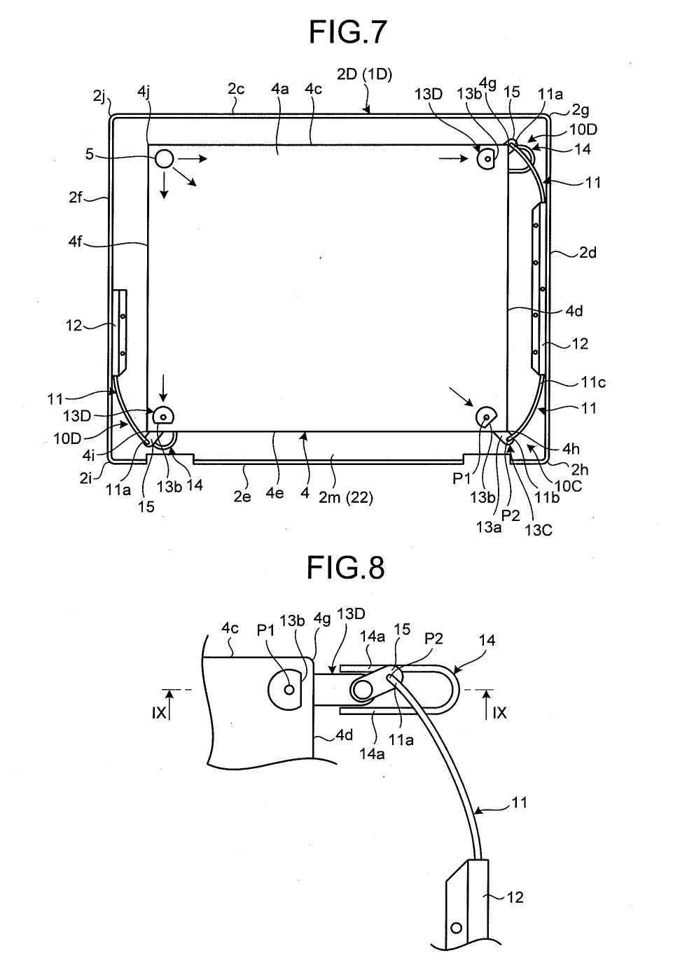

In the fourth embodiment, the configuration of a puller 10D illustrated on the upper right side and the lower left side in FIG. 7 differs from those of the above-described embodiments. That is, in the fourth embodiment, a housing 2D is provided with guides 14 each of which guides the movement of a connection portion 13D, for example. The guide 14 has two walls 14a (protrusions or ribs) that are in parallel with each other and protrude toward the inside of the housing 2D (the wall 2k side or along the thickness direction) from the wall 2m of the housing 2D. The connection portion 13D (a connection member, an exerting member, a member, a slider, or a movable portion) is inserted between the two walls 14a and movable along the extending direction of the walls 14a. That is, the guide 14 suppresses the connection portion 13D from moving off from a predetermined direction. According to the embodiment, the guide 14 suppresses the connection portion 13D from moving in an inconvenient direction, thereby determining the direction of force acting on the display 4, for example. As a result, the display 4 is readily prevented from loosening or obtaining wrinkles thereon caused by the pullers 10D pulling the display 4 in the inconvenient direction, for example.

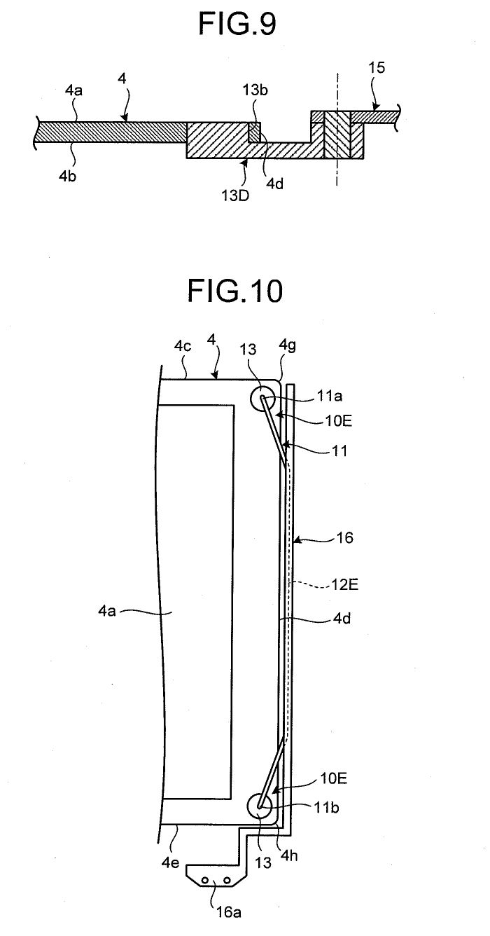

In addition, in the embodiment, as exemplarily illustrated in FIGS. 8 and 9, a linking member 15 is provided between the spring member 11 and the connection portion 13D and moves rotatably (swingably) about a shaft extending in the thickness direction of the display 4 (housing 2D). The linking member 15 is rotatably connected to the spring member 11 and the connection portion 13D. As a result, according to the embodiment, a change in magnitude of force acting on the display 4 from the spring member 11 depending on the position of the connection portion 13D is readily suppressed, for example.

The configurations of the following modifications can be substituted for the corresponding configuration of the respective above-described embodiments. Ina first modification, as exemplarily illustrated in FIG. 10, a connection portion 12E of a puller 10E having the spring member 11 is supported by (connected to or fixed to) a reinforcement member 16 that reinforces the housing 2B (refer to FIG. 4). The reinforcement member 16 (a shell member, a metallic member, a member, a frame, or a metal plate) is positioned at the edges 2d and 2f inside the housing 2B and extends along a direction intersecting the rotation axis Ax (refer to FIG. 4) (in the embodiment, e.g., along a direction orthogonal to the rotation axis Ax or along the edges 2d and 2f) in a belt-like shape (a rod-like or a platy shape). An edge 16a at one side in the longitudinal direction of the reinforcement member 16 is connected (bonded or fixed) to a component (not illustrated) of the hinge 9 (refer to FIG. 4). According to the first modification, the puller 10E is relatively readily provided and more tightly fixed to the housing 2B.

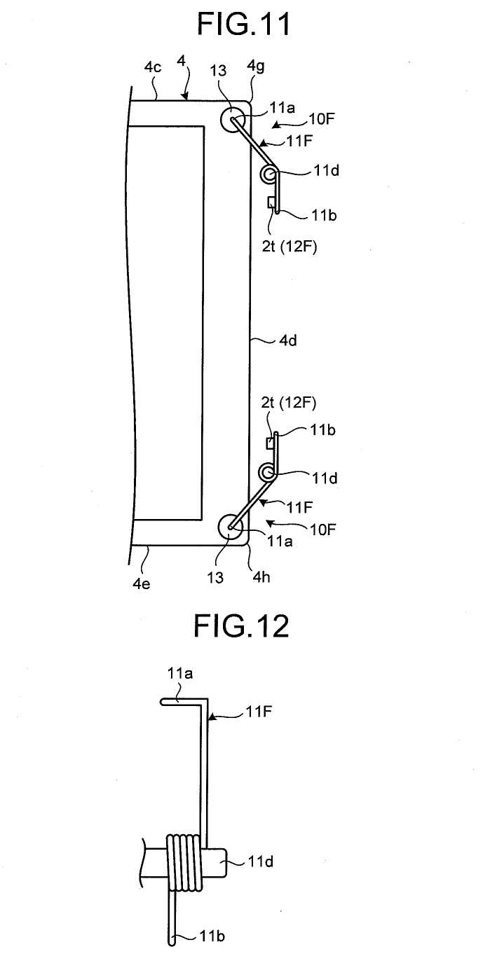

In a second modification, as exemplarily illustrated in FIGS. 11 and 12, a puller 10F has a spring member 11F serving as a torsion spring. The spring member 11F is winded around a shaft 11d. The shaft 11d extends along the thickness direction of the housing 2B. An edge 11a at one side of the spring member 11F is connected to the connection portion 13 while an edge 11b at the other side of the spring member 11F is connected to (engaged with or hooked by) a protrusion 2t of the housing 2B. The protrusion 2t is an example of a connection portion 12F. The spring members 11F urge the connection portions 12F, in other words, the corners 4g and 4h of the display 4 in directions toward the upper right side and lower right side, respectively, in FIG. 11 in plan view (when viewed in the thickness direction of the housing 2B). The second modification also enables the pullers 10F having the spring member 11F to impart tensional force to the display 4. In addition, according to the modification, the puller 10F can be achieved in a simpler structure.

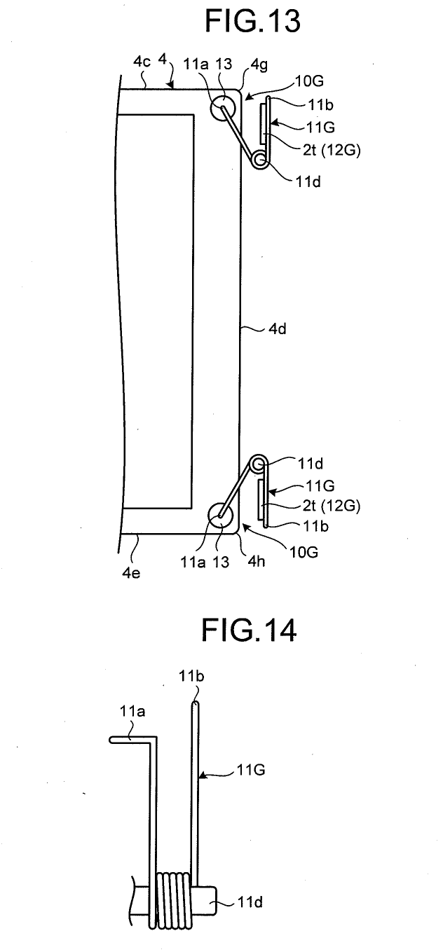

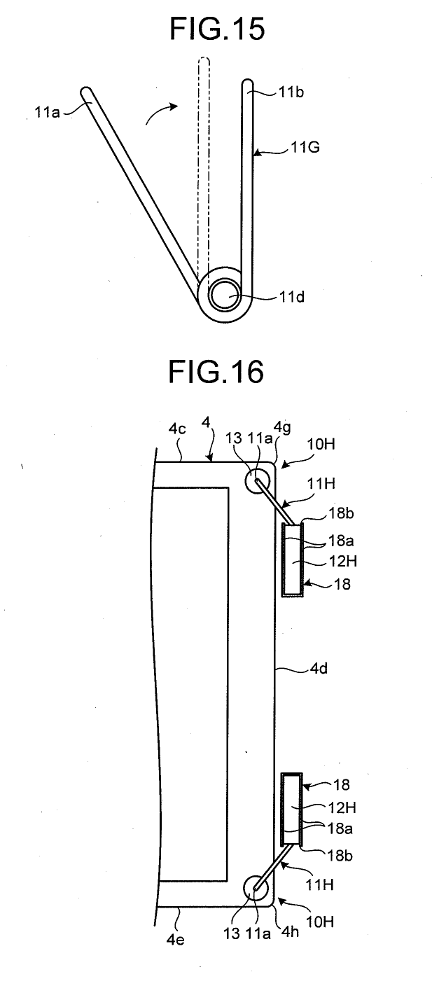

In a third modification, as exemplarily illustrated in FIGS. 13 to 15, a puller 10G has a spring member 11G serving as a torsion spring. The spring member 11G is winded around the shaft 11d. The shaft 11d extends along the thickness direction of the housing 2B. The edge 11a at one side of the spring member 11G is connected to the connection portion 13 while the edge 11b at the other side of the spring member 11G is connected to (engaged with or hooked by) the protrusion 2t of the housing 2B. The protrusion 2t is an example of a connection portion 12G. The spring members 11G urge the connection portions 12G, in other words, the corners 4g and 4h of the display 4 in directions toward the upper right side and lower right side, respectively, in FIG. 13 in plan view (when viewed in the thickness direction of the housing 2B). That is, the spring member 11G according to the third modification has the same function as the spring member 11F according to the second modification while the shape differs from that of the spring member 11F. The modification also enables the pullers 10G having the spring member 11G to impart tensional force to the display 4. In addition, according to the modification, the puller 10G can be achieved in a simpler configuration.

In the first to the third modifications illustrated in FIGS. 10, 11, and 13, the pullers 10E to 10G partially overlap with the display 4 in the thickness direction of the housing 2B (the thickness direction of the display 4). Accordingly, the width between the opening 2r and most outer edges of the edges 2c to 2f of the housing 2B is more readily reduced than a case when the pullers 10E to 10G do not overlap with the display 4, for example. As a result, the size of the display 4 in plan view is readily more reduced, for example.

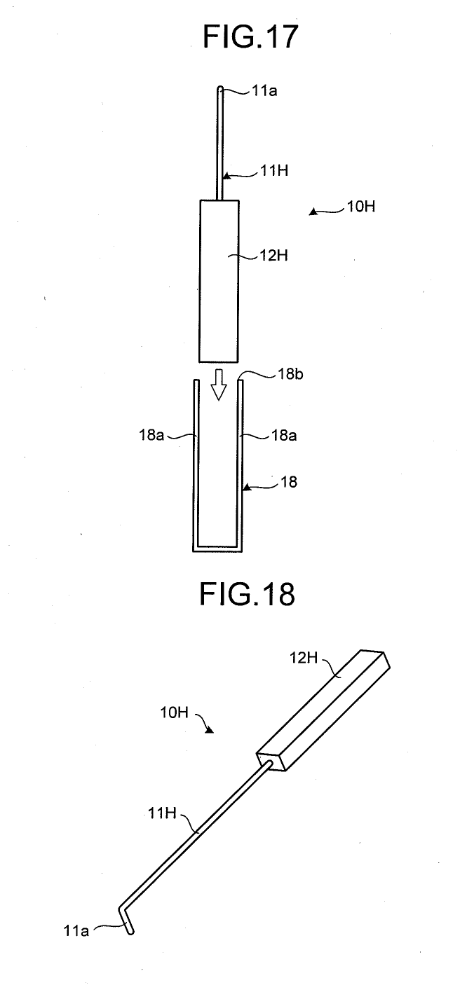

In a fourth modification, as exemplarily illustrated in FIGS. 16 to 18, a connection portion 12H of a puller 10H is fitted with pressure in a joint 18 provided to the housing 2B and fixed to the joint 18. The connection portion 12H has an elongated rectangular parallelepiped shape and extends on the extended line of a spring member 11H with an approximately constant width. The joint 18 has two walls 18a (protrusions or ribs) that are in parallel with each other and protrude toward the inside of the housing 2B (the wall 3k side or along the thickness direction) from the wall 2m of the housing 2B. As illustrated in FIG. 17, the connection portion 12H is fitted in a space between the walls 18a from an opening 18b of the joint 18 with pressure. According to the fourth modification, the pullers 10H are relatively readily attached to the housing 2B.

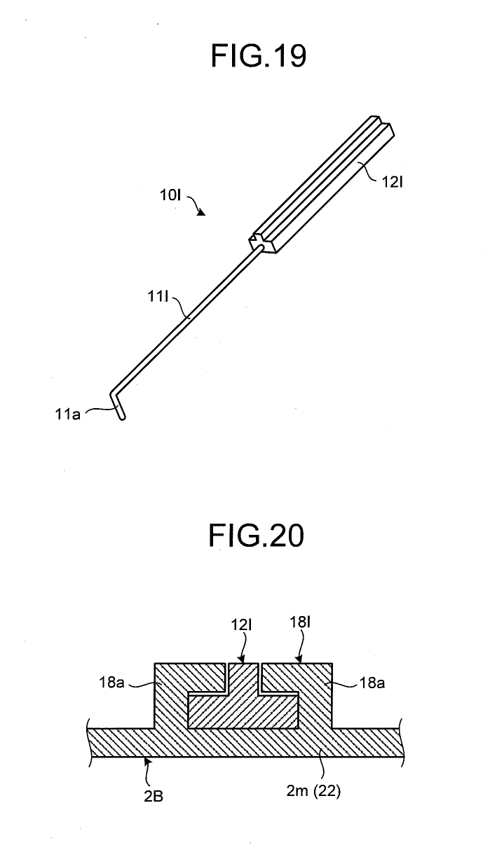

In a fifth modification, as exemplarily illustrated in FIGS. 19 and 20, a connection portion 12I of a puller 10I is fitted with pressure in a joint 18I provided to the housing 2B and fixed to the joint 18I. The connection portion 12I has an inverted T-section and elongates on the extended line of a spring member 11I. A wall 18a of the joint 18I has an inverted L-section (a hook-like section) along the cross-sectional shape of the connection portion 12I. That is, the connection portion 12I is hooked by the wall 18a, thereby being suppressed from being released from the wall 2m in a direction away from the wall 2m. According to the fifth modification, the puller 10I is hardly released from the housing 2B.

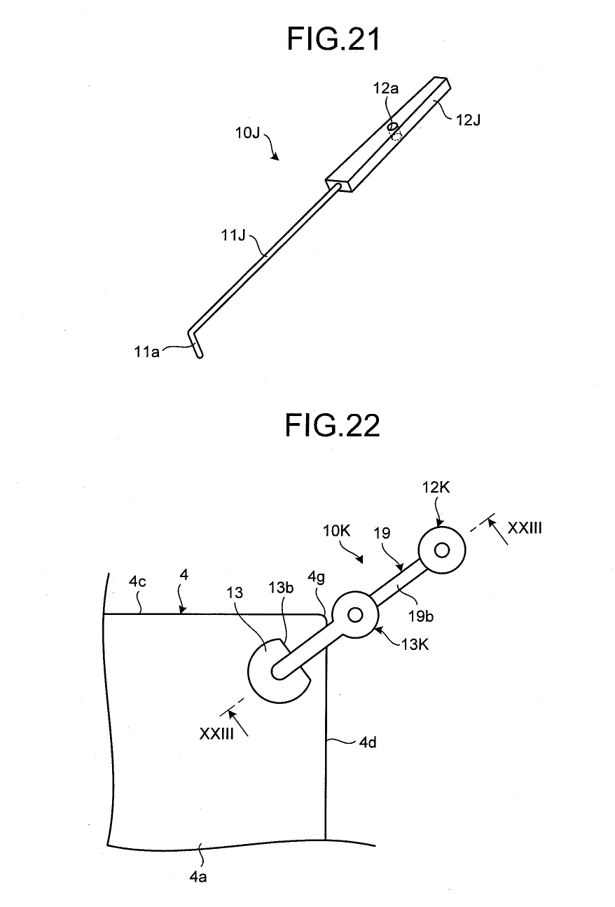

In a sixth modification, as exemplarily illustrated in FIG. 21, a connection portion 12J of a puller 10J is fitted with pressure in a joint, which is not illustrated but is the same as the joint 18 or 18I provided to the housing 2B illustrated in FIGS. 16 and 17, or FIG. 20, and fixed to the joint. In the sixth modification, the connection portion 12J has a quadrangular section and extends on the extended line of a spring member 11J. The width of the connection portion 12J at the front edge side thereof is narrower than that at the tail edge (base) side in the pressure-fitting direction, i.e., the connection portion 12J has a so-called tapered shape. According to the sixth modification, the connection portion 12J is relatively readily inserted in the joint of the housing 2B because the connection portion 12J has the tapered shape. In addition, the connection portion 12J is provided with an opening 12a (e.g., a through hole or a recess) extending along the thickness direction of the housing 2B. In the modification, the opening 12a can be used as a positioning in the pressure-fitting direction. That is, in the modification, the puller 10J is fixed to the housing 2B by fitting the connection portion 12J in the joint with pressure, and in the pressure-fitting process, a projection (or a protrusion, which is not illustrated) and the opening 12a hook into each other, thereby positioning the connection portion 12J in the pressure-fitting direction. According to the modification, the puller 10J is more readily attached to the housing 2B with higher accuracy. The pullers 10H to 10J according to the fourth to the sixth modifications can be fixed to the corresponding portions at which the joint 18 and 18I are provided to the housing 2B by adhesive bonding, welding, or joints (e.g., screws), for example.

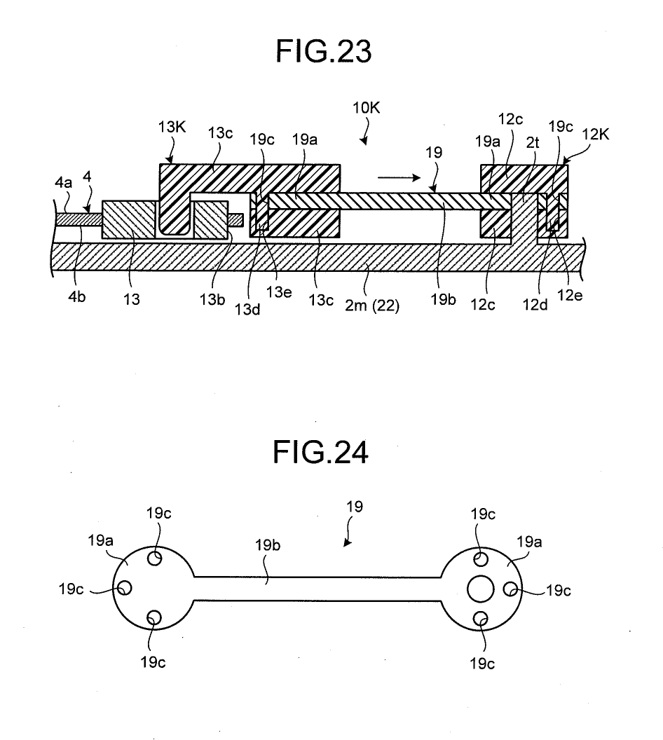

In a seventh modification, as exemplarily illustrated in FIGS. 22 to 24, a puller 10K has an elastomer 19 (an elastic member) instead of the spring member. The elastomer 19 has two joint portions 19a (connection portions) and an extending portion 19b (an extending portion, or an elastically deforming portion) having a belt-like shape and extending between the two joint portions 19a. The joint portions 19a are fixed to respective connection portions 12K and 13K. Each of the connection portions 12K and 13K is divided in the thickness direction. Divided bodies 12c and 13c are integrated while sandwiching the joint portions 19a. The joint portions 19a are provided with through holes 19c. Projections 12d and 13d (protruding portions) provided to the divided bodies 12c and 13c at one side, respectively, are passed through the respective through holes 19c and fitted with pressure in holes 12e and 13e (openings) provided to the divided bodies 12c and 13c at the other side, respectively. The connection portion 12K is supported by the protrusion 2t of the housing 2B while the connector 13K is connected to the connector 13. The free length of the extending portion 19b is set to be shorter than the distance between the connection portions 12K and 13K. Accordingly, the elastomer 19 is attached between the connection portions 12K and 13K while elastically elongated. As a result, the seventh modification also enables the puller 10K having the elastomer 19 to impart tensional force to the display 4.

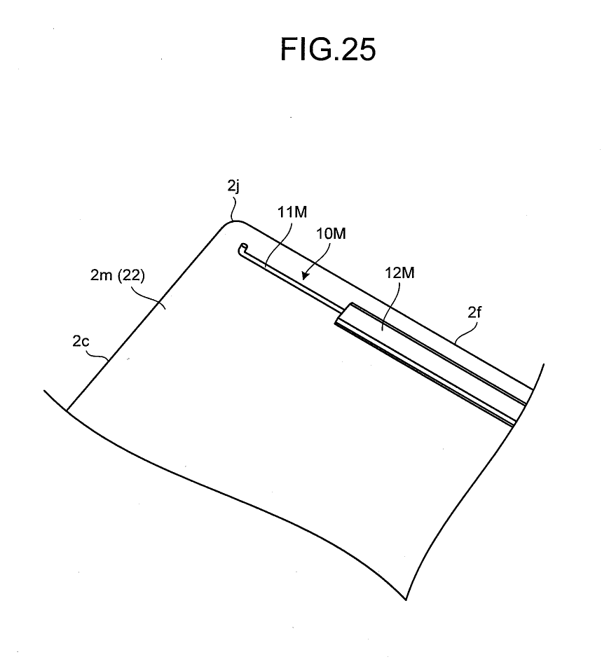

In an eighth modification, as exemplarily illustrated in FIG. 25, a puller 10M is integrally formed with the wall 2m of the housing 2B. The puller 10M has a connection portion 12M and a spring portion 11M (a spring member). The spring portion 11M extends approximately in parallel with the wall 2m with a certain distance therebetween and along the wall 2m. The puller 10M can be obtained by forming a gap between the wall 2m and the spring portion 11M using a sliding mold when the housing 2B is formed by die casting or injection molding, for example. According to the eighth modification, time in assembling the puller 10M is readily reduced.

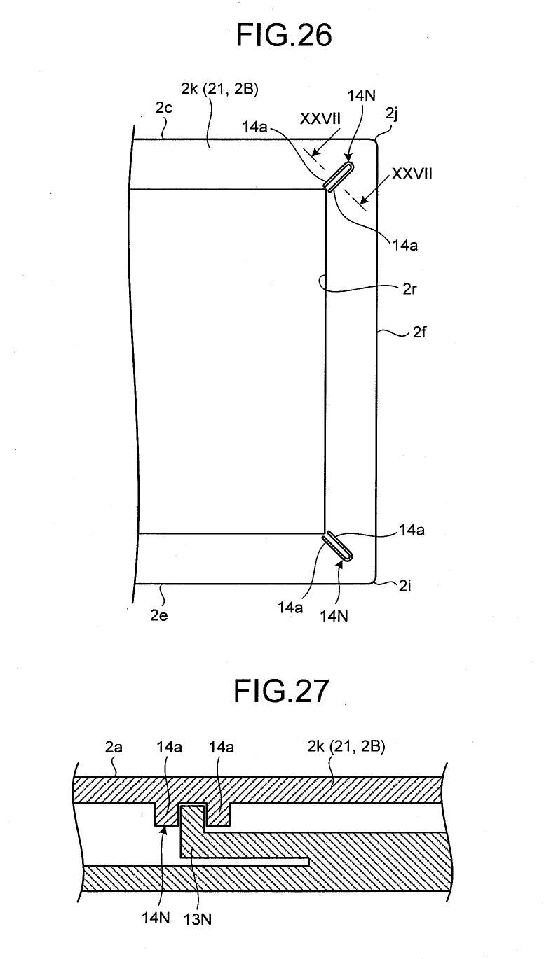

In a ninth modification, as exemplarily illustrated in FIGS. 26 and 27, guides 14N each of which guides the movement of connector 13N provided to the display 4 are provided on the wall 2k of the housing 2B. The guide 14N has two walls 14a (protrusions or ribs) that are in parallel with each other and protrude toward the inside of the housing 2B (the wall 2m side or along the thickness direction) from the wall 2k of the housing 2B. The connector 13N (the connection member, the exerting member, the member, the slider, or the movable portion) connected to the display 4 is inserted between the two walls 14a and movable along the extending direction of the walls 14a. That is, the guide 14N suppresses the connector 13N from moving off from a predetermined direction. According to the ninth modification, the guide 14N suppresses the connector 13N from moving in an inconvenient direction, thereby determining the direction of force acting on the display 4, for example. As a result, the display 4 is readily prevented from loosening or having wrinkles thereon caused by the pullers (not illustrated) pulling the display 4 in the inconvenient direction, for example.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions. The configurations and shapes of the components in the embodiments described above can be partially replaced with each other to put them into practice. In addition, the specifications (e.g., the structure, type, direction, shape, size, length, width, thickness, height, number of pieces, arrangement, position, and material) of these configurations and shapes, for example, can be changed as appropriate.

What is claimed is:

1. A television receiver comprising:
a bendable display comprising a front surface at which an image can be viewed and a rear surface opposite the front surface;
a housing configured to support the display, the housing comprising a wall covering the rear surface; and
a puller between the housing and the display, configured to impart tensional force to the display by pulling the display in a plurality of directions along the front surface.

2. The television receiver of claim 1, wherein the puller is configured to pull the display from a center of the display toward both sides between which the center is interposed.

3. The television receiver of claim 1, wherein
an edge at one side of the display is configured to be supported by the housing, and
the puller is configured to pull an edge at other side of the display in a direction toward a side opposite the edge at the one side.

4. The television receiver of claim 3, wherein
a first corner of the display is configured to be supported by the housing, and
the puller is configured to pull a second corner of the display in a direction toward a side opposite the first corner.

5. The television receiver of claim 4, wherein
the display is formed in a quadrangular shape, and
the puller is configured to pull three corners of the display different from the first corner in directions toward sides opposite the first corner.

6. The television receiver of claim 4, wherein the first corner is positioned at an upper side of the display during usage of the display.

7. The television receiver of claim 1, wherein the puller is provided on the wall.

8. The television receiver of claim 1, further comprising a guide configured to guide a movement of a portion at which the display is pulled by the puller.

9. The television receiver of claim 1, wherein the puller has a pulling member configured to pull a plurality of portions of the display.

10. The television receiver of claim 1, wherein at least a portion of the puller and at least a portion of the display overlap with each other in a thickness direction of the display.

11. An electronic device comprising:
a bendable display comprising a front surface at which an image can be viewed and a rear surface opposite the front surface;
a housing configured to support the display, the housing comprising a wall covering the rear surface; and
a puller between the housing and the display, configured to impart tensional force to the display by pulling the display in a plurality of directions along the front surface.

12. An electronic device comprising:
a flexible display comprising a front surface at which an image can be viewed and a rear surface opposite the front surface;
a housing configured to support the display; and
a puller configured to pull the display in a plurality of directions along the front surface.
